(19) United States
(12) Patent Application Publication
(10) Pub. No.: US 2015/0014441 A1
(43) Pub. Date: Jan. 15, 2015

(54) SPRAYING APPARATUS

(71) Applicants: FU DING ELECTRONICAL TECHNOLOGY (JIASHAN COUNTY), Zhejiang (CN); HON HAI PRECISION INDUSTRY CO., LTD., New Taipei (TW)

(72) Inventors: DAO-PING KAN, Jiashan (CN); YI-FEI YAO, Jiashan (CN)

(21) Appl. No.: 14/326,617

(22) Filed: Jul. 9, 2014

(30) Foreign Application Priority Data
Jul. 10, 2013 (CN) 2013204088205

(51) Int. Cl. F16N 7/34; B05B 7/04; B05B 7/24

(52) U.S. Cl. CPC F16N 7/34; B05B 7/2489; B05B 7/0416
USPC 239/311

(57) ABSTRACT

An apparatus for spraying an oil mist on a pull-push basis includes a vacuum generator, a gas transport assembly, an oil transport assembly, and a nozzle. The vacuum generator defines a vacuum chamber. The gas transport assembly can include a gas transport pipe. The gas transport pipe couples an outer high pressure gas source with the vacuum chamber. The oil transport assembly includes an oil transport pipe. The oil transport pipe couples an outer oil tank with the vacuum chamber. The nozzle is coupled to the vacuum chamber and is separated from the gas transport pipe. Oil in the oil transport pipe is sucked into the vacuum chamber when at low pressure and, when a high pressure gas burst is provided to the vacuum generator, an oil mist is sprayed out from the nozzle.

### FIELD

The subject matter herein generally relates to lubrication and cooling.

### BACKGROUND

During a machining process, a spraying apparatus is applied to spray oil mist to a machining tool and/or a workpiece for lubricating and cooling.

### BRIEF DESCRIPTION OF THE DRAWINGS

Implementations of the present technology will now be described, by way of example only, with reference to the attached figures.

FIG. 1 is an assembled, isometric view of an embodiment of a spraying apparatus for spraying oil mist.

FIG. 2 is a diagrammatic view of the spraying apparatus of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A spraying apparatus can include a vacuum generator, a gas transport assembly, an oil transport assembly, and a nozzle. The vacuum generator can define a vacuum chamber. The gas transport assembly can include a gas transport pipe. The gas transport pipe can couple an outer high pressure gas source with the vacuum chamber. The oil transport assembly can include an oil transport pipe. The oil transport pipe can couple an outer oil tank with the vacuum chamber. The nozzle can be coupled to the vacuum chamber. On a pull-push basis, oil transported by the oil transport pipe can be pulled into the vacuum chamber and when a burst of high pressure gas is provided to the vacuum generator for generating vacuum, and an oil mist will be sprayed out from the nozzle.

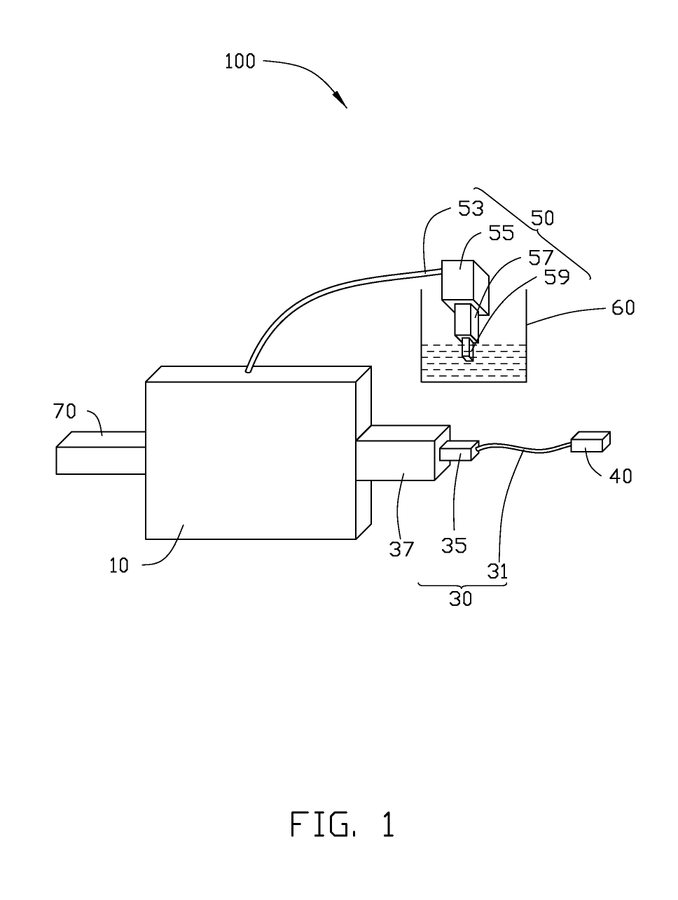

FIG. 1 illustrates a spraying apparatus 100 for spraying an oil mist (not shown) onto a machining tool (not shown) and/or a workpiece (not shown) for lubricating and cooling the machining tool and/or the workpiece during machining The spraying apparatus 100 can include a vacuum generator 10, a gas transport assembly 30, an oil transport assembly 50, and a nozzle 70. The vacuum generator 10 can be coupled the gas transport assembly 30 with the nozzle 70, and the vacuum generator 10 can further be coupled the oil transport assembly 50 with the nozzle 70. The high pressure gas can flow through the gas transport assembly 30 into the vacuum generator 10, and then be sprayed out from the nozzle 70. A pressure of the vacuum generator 10 will be lower than the pressure in the oil transport assembly 50. A vacuum will be generated in the vacuum generator 10, and the oil can be pulled into the vacuum generator 10 accordingly. Furthermore, the high pressure gas causes the oil in the vacuum generator 10 to form a mist, and the oil mist can be sprayed out from the nozzle 70 onto the machining tool and/or the workpiece.

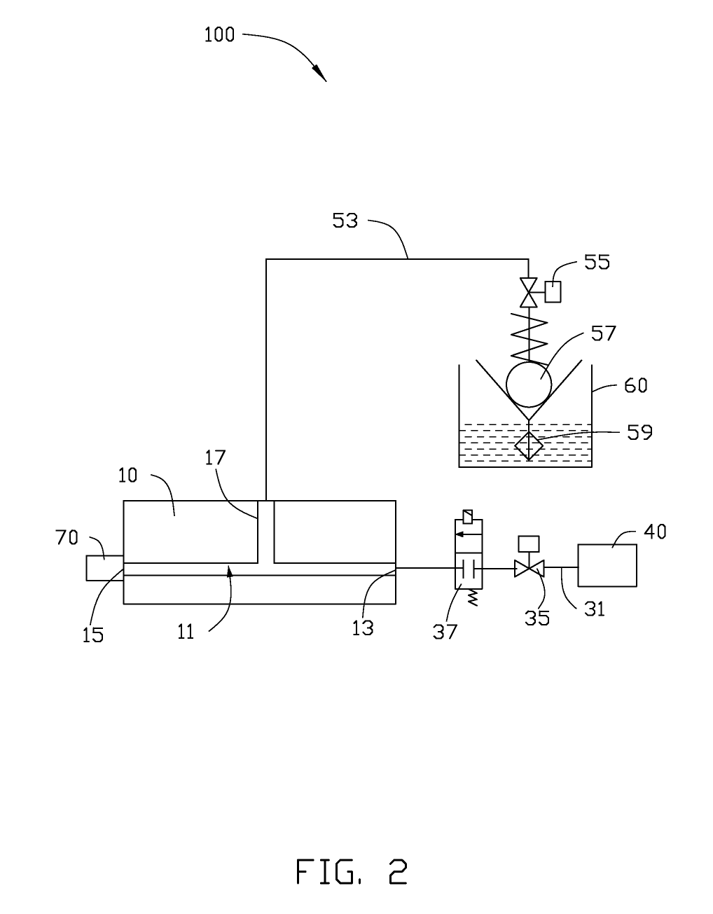

FIG. 2 illustrates a diagrammatic view of the spraying apparatus of FIG. 1. The vacuum generator 10 can be in a substantially rectangular shape. The vacuum generator 10 can define a vacuum chamber 11 along an extension direction of the vacuum generator 10. A gas inlet 13 and a gas outlet 15 can be positioned at opposite ends of the vacuum generator 10. The vacuum generator 10 can couple the gas inlet 13 with the gas outlet 15. An oil inlet 17 can be defined in a sidewall of the vacuum chamber 11. In at least one embodiment, an axis of the oil inlet 17 is substantially perpendicular to an axis of the vacuum chamber 11.

The gas transport assembly 30 can be coupled to the gas inlet 13. The gas transport assembly 30 can include a gas transport pipe 31, a first speed control valve 35, and an electromagnetic valve 37 coupled to the first speed control valve 35. One end of the gas transport pipe 31 can be coupled with an outer high pressure gas source 40 (as FIG. 1 shown), and the other end of the gas transport pipe 31 can be coupled with gas inlet 13 via both the first speed control valve 35 and the electromagnetic valve 37, and the gas transport pipe 31 can transport the high pressure gas to the vacuum generator 10. The first speed control valve 35 can be located between the electromagnetic valve 37 and the high pressure gas source 40, and can be used for controlling a flow rate of the high pressure gas flowing in the gas transport pipe 31. The electromagnetic valve 37 can be located between the gas inlet 13 and the first speed control valve 35 and can be used for controlling the gas transport pipe 31 to open or close, to provide gas in high and low pressure bursts. The high pressure gas can be provided to the vacuum chamber 11 of the vacuum generator 10 under the control of both the first speed control valve 35 and the electromagnetic valve 37, and can be sprayed out from the nozzle 70 at a high speed. The vacuum generator 10 then has a gas pressure which is lower than the pressure in the oil transport assembly 50, and the oil thus can be pulled into the vacuum chamber 11.

The oil transport assembly 50 can couple the oil inlet 17 with an outer oil tank (not shown) and is used for transporting oil from the outer oil tank to the vacuum chamber 11. The oil transport assembly 50 can include an oil transport pipe 53, a one-way valve (unidirectional valve) 57, a second flow control valve 55, and a filter 59. The oil transport pipe 53 can be coupled with the oil inlet 17. The second flow control valve 55 can be located between the one-way valve 57 and the oil inlet 17, and can be used for controlling a flow rate of the oil flowing in the oil transport pipe 53. The unidirectional valve 57 can be positioned on one end of the oil transport pipe 53 away from the oil inlet 17 for preventing backflow of the oil to the outer oil tank 60 again. The filter 59 can be coupled to the unidirectional valve 57 to filter impurities from the oil.

The nozzle 70 can be coupled to the gas outlet 15 and can be used for spraying the oil mist.

In operation, the flow rate of the first speed control valve 35 can be adjusted to a predetermined value, and the electromagnetic valve 37 can be controlled to open, and the high pressure gas flows through the gas transport pipe 31 into the vacuum chamber 11 and is then released through the nozzle 70 at a high speed. The pressure of the vacuum generator 10 then being less than the pressure of the oil transport assembly 50, more oil will be sucked into the vacuum generator 10. The oil mist will be formed and sprayed from the nozzle 70 and then sprayed on the machining tool and/or the workpiece.

In at least one embodiment, the first speed control valve 35, the electromagnetic valve 37, the unidirectional valve 57, the second flow control valve 55, and the filter 59 can be omitted, the gas transport pipe 31 can be directly coupled between the vacuum generator 10 and the outer high pressure source, and the oil mist can be directly provided to the vacuum generator 10 from the outer oil tank via the oil transport pipe.

The embodiments shown and described above are only examples. Many details are often found in the art such as the other features of a vacuum generator. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A spraying apparatus comprising:
a vacuum generator defining a vacuum chamber;
a gas transport assembly comprising a gas transport pipe coupled with an outer high pressure gas source and the vacuum chamber;
an oil transport assembly comprising an oil transport pipe coupled with an outer oil tank and the vacuum chamber; and
a nozzle coupled with the vacuum chamber, whereby an oil mist will be sprayed out from the nozzle based on a high pressure gas being provided to the vacuum generator wherein oil transported by the oil transport pipe is pulled into the vacuum chamber.

2. The spraying apparatus of claim 1, wherein the vacuum generator defines a gas transport and a gas outlet, the gas inlet and the gas outlet are positioned at opposite ends of the vacuum generator, the gas transport is coupled with the gas transport pipe, the gas outlet is coupled to the nozzle.

3. The spraying apparatus of claim 2, wherein the gas transport assembly further comprises an electromagnetic valve, the electromagnetic valve is coupled between the gas transport pipe and the gas inlet for controlling the gas transport pipe to open or close.

4. The spraying apparatus of claim 3, wherein the gas transport assembly further comprises a first flow control valve, the first speed control valve is coupled between and coupling with the electromagnetic valve and the gas transport pipe for controlling a flow rate of the high pressure gas flowing in the gas transport pipe.

5. The spraying apparatus of claim 1, wherein the gas transport assembly further comprises a first speed control valve, the first speed control valve is coupled between the vacuum generator and the gas transport pipe for controlling a flow rate of the high pressure gas flowing in the gas transport pipe.

6. The spraying apparatus of claim 1, wherein the vacuum generator defines an oil inlet couples with the vacuum chamber, the oil transport assembly further comprises a one-way valve located on the oil pipe for avoiding the oil to flow to the outer oil tank again.

7. The spraying apparatus of claim 6, wherein the oil transport assembly further comprises a second flow control valve, the second flow control valve is located between the unidirectional valve and the oil inlet for controlling a flow rate of oil flowing in the oil transport pipe.

8. The spraying apparatus of claim 6, wherein the oil transport assembly further comprises a filter coupled to one end of unidirectional valve away from the oil pipe.
